(19) United States
(12) Patent Application Publication
(10) Pub. No.: US 2017/0153791 A1
(43) Pub. Date: Jun. 1, 2017

(54) CONDITIONAL ANIMATION OF AN ICON

(71) Applicant: Linkedln Corporation, Mountain View, CA (US)

(72) Inventors: Samish Chandra Kolli, Mountain View, CA (US); Tomer Cohen, Mountain View, CA (US); Vivek Tripathi, Mountain View, CA (US); Aarthi Jayaram, Mountain View, CA (US); Corine Yang, Mountain View, CA (US)

(21) Appl. No.: 14/973,342

(22) Filed: Dec. 17, 2015

Related U.S. Application Data
(60) Provisional application No. 62/261,601, filed on Dec. 1, 2015.

(51) Int. Cl. G06F 3/0481; G06T 1/60; G06T 11/00; G06T 13/80; G06F 3/0484

(52) U.S. Cl. CPC G06F 3/04817; G06T 13/80; G06F 3/04842; G06T 11/001; G06T 1/60

(57) ABSTRACT

This disclosure relates to systems and methods for modifying icon pixels using a badge algorithm. In one example, a method includes receiving an indicator that media content is available, the indicator identifying a badge algorithm among a plurality of badge algorithms; rendering icon pixels to a graphics memory; executing the badge algorithm to modify one or more of the icon pixels by writing to the graphics memory; and causing the icon pixels to be displayed on a display screen.

### RELATED APPLICATIONS

This application claims the priority benefit of U.S. Provisional Application No. 62/261,601, entitled “MODIFYING ICON PIXELS ACCORDING TO A BADGE ALGORITHM,” filed Dec. 1, 2015, which is hereby incorporated herein by reference in its entirety.

### TECHNICAL FIELD

The subject matter disclosed herein generally relates to digital graphics and, more particularly, to modifying icon pixels according to a badge algorithm.

### BACKGROUND

As members of an online social networking service interact with their respective mobile devices they typically experience a range of graphical user elements, including icons. In some scenarios, icons are static in nature and loaded from storage that is local to the device.

However, as data changes in the electronic world outside of the mobile device, the member may not become aware of the changes because of the static nature of the icons. In other scenarios, an icon is modified to indicate reception or availability of data. However, notifying the member that additional media content is available without distracting the member is difficult when the member is viewing alternate user interfaces.

### BRIEF DESCRIPTION OF THE DRAWINGS

Some embodiments are illustrated by way of example and not limitation in the figures of the accompanying drawings.

FIG. 1 is a block diagram illustrating various components or functional modules of an online social networking service, in an example embodiment.

FIG. 2 is a block diagram illustrating a system for modifying icon pixels according to a badge algorithm, according to one example embodiment.

FIG. 3 is a block diagram illustrating another system for modifying icon pixels according to a badge algorithm, according to one example embodiment.

FIG. 4 is a block diagram illustrating a system for modifying icon pixels according to a badge algorithm, according to an example embodiment.

FIG. 5 is an illustration depicting modifications to an icon using a badge algorithm, according to an example embodiment.

FIG. 6 is an illustration depicting a user interface, according to one example embodiment.

FIG. 7 is a flow chart diagram illustrating a method of modifying icon pixels according to a badge algorithm, according to another example embodiment.

FIG. 8 is a flow chart diagram illustrating another method of modifying icon pixels using a badge algorithm, according to another example embodiment.

FIG. 9 is a block diagram illustrating components of a machine, according to some example embodiments, able to read instructions from a machine-readable medium (e.g., a machine-readable storage medium) and perform any one or more of the methodologies discussed herein

### DETAILED DESCRIPTION

The description that follows includes systems, methods, techniques, instruction sequences, and computing machine program products that embody the inventive subject matter. In the following description, for the purposes of explanation, numerous specific details are set forth in order to provide an understanding of various embodiments of the inventive subject matter. It will be evident, however, to those skilled in the art, that embodiments of the inventive subject matter may be practiced without these specific details. In general, well-known instruction instances, protocols, structures, and techniques are not necessarily shown in detail.

Example methods and systems are directed to modifying icon pixels according to a badge algorithm according to one example embodiment. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, techniques for modifying icon pixels according to a badge algorithm include receiving an indicator that identifies a badge algorithm from among a plurality of badge algorithms, rendering pixels of the icon to a graphics memory, executing the identified badge algorithm to modify the icon pixels, and causing the modified pixel data to be displayed on a display screen.

In one example, a system renders an icon of a house in a graphics memory and receives an indicator from a remote computing device. In one example, the remote computing device is a server. In this example, in response to additional media content being available for display, the remote computing device transmits the indicator to the system. In one example, the indicator indicates a badge algorithm that adds smoke to a chimney for the icon of the house. In response, the system modifies the pixel data according to the badge algorithm and displays the modified pixel data to display an icon of the house with the smoke by the chimney of the house.

One benefit of displaying modified pixel data is that, in one embodiment, a user of the system is more immediately notified of changes to data at the remote computing device. Because the remote computing device may not effectuate modification to an icon at the system, the user may be notified without significant changes to the user interface at the system. Such an approach notifies the user without disrupting activities by the user at the system. Furthermore, because the remote computing device may identify a badge algorithm to execute, the corresponding change to the pixels of the icon may indicate a wide variety of different conditions. In this way, means are provided for a remote computing device to cause a wide variety of different icons and animations to be displayed via the system.

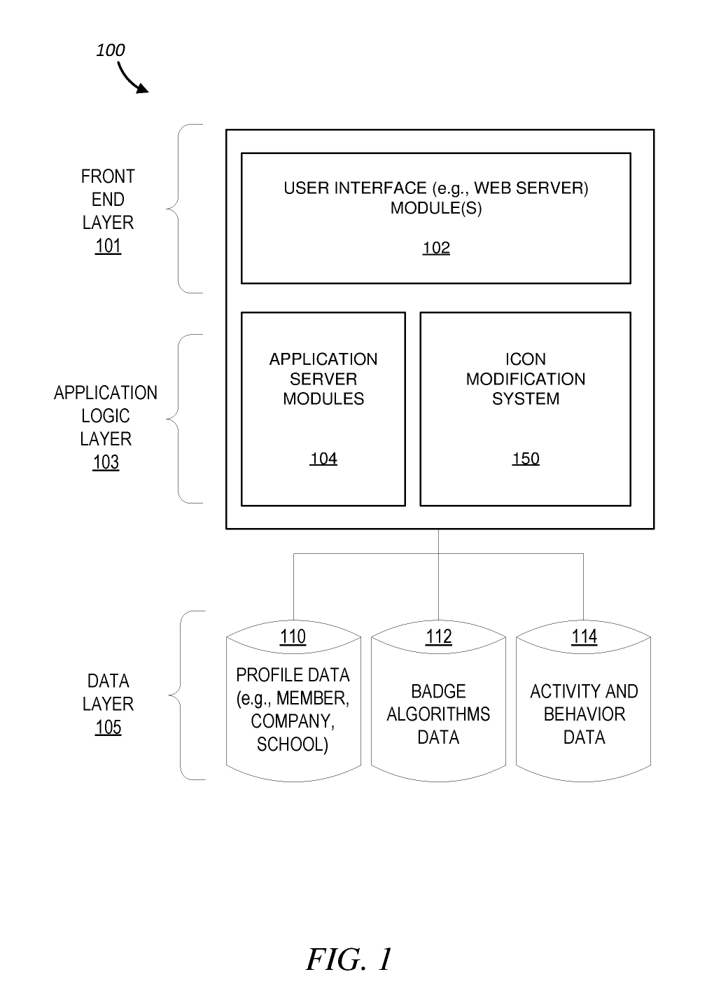

FIG. 1 is a block diagram illustrating various components or functional modules of an online social networking service 100, in an example embodiment. The online social networking service 100 may be utilized to modify an icon displayed at a client device. In one example, the online social networking service 100 includes an icon modification system 150 that performs the various operations described herein.

A front end layer 101 consists of one or more user interface modules (e.g., a web server) 102, which receive requests from various client computing devices and communicate appropriate responses to the requesting client devices. For example, the user interface module(s) 102 may receive requests in the form of Hypertext Transfer Protocol (HTTP) requests, or other web-based, application programming interface (API) requests. In another example, the front end layer 101 receives requests from an application executing via a member's mobile computing device. In one example, a member submits media content to be transmitted to other members of the online social networking service 100.

An application logic layer 103 includes various application server modules 104, which, in conjunction with the user interface module(s) 102, may generate various user interfaces (e.g., web pages, applications, etc.) with data retrieved from various data sources in a data layer 105. In one example embodiment, the application logic layer 103 includes the icon modification system 150.

In some examples, individual application server modules 104 may be used to implement the functionality associated with various services and features of the online social networking service 100. For instance, the ability of an organization to establish a presence in the social graph of the online social networking service 100, including the ability to establish a customized web page on behalf of an organization, and to publish messages or status updates on behalf of an organization, may be services implemented in independent application server modules 104. Similarly, a variety of other applications or services that are made available to members of the online social networking service 100 may be embodied in their own application server modules 104. Alternatively, various applications may be embodied in a single application server module 104. In some examples, the online social networking service 100 includes the icon modification system 150, which renders an icon, receives an indication identifying a badge algorithm to modify the icon, and causes the icon to be displayed.

As illustrated, the data layer 105 includes, but is not necessarily limited to, several databases 110, 112, 114, such as a database 110 for storing profile data, including both member profile data and profile data for various organizations. In certain examples, a badge algorithms database 112 includes a plurality of badge algorithms to modify pixel data for an icon as described herein. In other examples, the user interface modules 102 are configured to receive additional badge algorithms to be included in the badge algorithms database 112.

Consistent with some examples, when a person initially registers to become a member of the online social networking service 100, the person may be prompted to provide some personal information, such as his or her name, age (e.g., birthdate), gender, sexual orientation, interests, hobbies, contact information, home town, address, spouse's and/or family members' names, educational background (e.g., schools, majors, matriculation and/or graduation dates, etc.), occupation, employment history, skills, religion, professional organizations, and other properties and/or characteristics of the member. This information is stored, for example, in the database 110. Similarly, when a representative of an organization initially registers the organization with the online social networking service 100, the representative may be prompted to provide certain information about the organization. This information may be stored, for example, in the database 110, or another database (not shown). In some examples, the profile data may be processed (e.g., in the background or offline) to generate various derived profile data. For example, if a member has provided information about various job titles the member has held with the same or different companies, and for how long, this information can be used to infer or derive a member profile attribute indicating the member's overall seniority level, education level, or seniority level within a particular company. In some examples, importing or otherwise accessing data from one or more externally hosted data sources may enhance profile data for both members and organizations. For instance, with companies in particular, financial data may be imported from one or more external data sources, and made part of a company's profile. In one example, the database 110 includes a user's education level, current position title, current position location, position title, education level, position responsibilities, position field, position industry, or other position properties.

The online social networking service 100 may provide a broad range of other applications and services that allow members the opportunity to share and receive information, often customized to the interests of the member. For example, in some examples, the online social networking service 100 may include a message sharing application that allows members to upload and share messages with other members. In some examples, members may be able to self-organize into groups, or interest groups, organized around subject matter or a topic of interest. In some examples, the online social networking service 100 may host various job listings providing details of job openings within various organizations.

As members interact with the various applications, services, and content made available via the online social networking service 100, information concerning content items interacted with, such as by viewing, playing, and the like, may be monitored, and information concerning the interactions may be stored, for example, as indicated in FIG. 1 by the database 114. In one example embodiment, the interactions are in response to receiving a message requesting the interactions.

Although not shown, in some examples, the online social networking service 100 provides an API module via which third-party applications can access various services and data provided by the online social networking service 100. For example, using an API, a third-party application may provide a user interface and logic that enables the member to submit and/or configure a set of rules used by the icon modification system 150. Such third-party applications may be browser-based applications, or may be operating system specific. In particular, some third-party applications may reside and execute on one or more mobile devices (e.g., phones or tablet computing devices) having a mobile operating system.

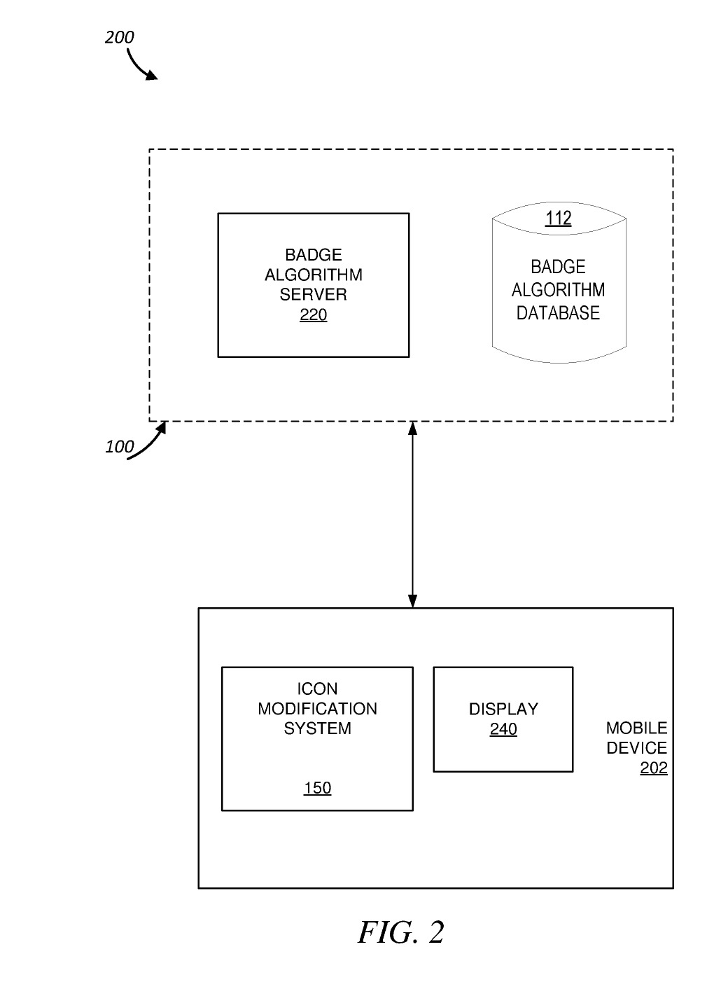

FIG. 2 is a block diagram illustrating a system 200 for modifying icon pixels according to a badge algorithm, according to one example embodiment. In this example embodiment, the system 200 includes the online social networking service 100 that includes a badge algorithm server 220 and the badge algorithm database 112, and a mobile device 202 that includes the icon modification system 150 and a display 240.

In one embodiment, the badge algorithm server 220 is configured to store many different badge algorithms. The badge algorithm server 220 may also receive badge algorithms from an administrator of the icon modification system 150. Over time, as many members of the online social networking service 100 use the icon modification system 150, the badge algorithm server 220 may include many different badge algorithms.

As described herein, a badge algorithm includes a series of operations performed to modify icon pixel data in a certain way. In one example, a badge algorithm is configured to add smoke coming out of a chimney of a house included in an icon. In another example, a badge algorithm is configured to add fireworks behind an image in an icon. In another example, a badge algorithm is configured to grow or shrink an image in an icon, change colors, change sizes, or vary graphical features of an image in the icon in other ways. Of course, one skilled in the art may recognize many other ways in which a badge algorithm may modify pixel data for an icon, and this disclosure is meant to include all such ways.

In one example embodiment, the badge algorithm modifies pixel data by overwriting pixel values in a memory buffer. In another example, the badge algorithm modifies pixel data by copying modified pixel data over current pixel data. In another example embodiment, the badge algorithm modifies pixel data by overlaying badge graphics on the icon. In another example embodiment, the badge algorithm combines icon pixel data with overlay pixel data and generates a composite icon that partially includes icon pixel data and partially includes data generated by the badge algorithm.

In one example, the badge algorithm includes some measure of transparency. In one example, the badge algorithm adds graphical elements to the icon pixel data wherein the graphical elements are added with 50% transparency. In this example, resulting pixel data is 50% from the icon pixel data, and 50% from the badge graphical elements. In another example, the transparency value is 0%. In this example, the graphical elements from the badge algorithm overwrite icon pixel data (i.e., the pixel data is modified to be consistent with the badge graphical elements, and icon pixel data at the location of the badge graphical elements is not considered). Of course, other transparency values may be used and this disclosure is not limited in this regard.

In one example embodiment, the badge algorithm server 220 stores the badge algorithms in the badge algorithm database 112. The badge algorithm database 112 may be configured according to any number of known database formats and systems, as one skilled in the art may appreciate. In one specific example, the badge algorithm database 112 is a structured query language (SQL) database.

In one example embodiment, the icon modification system 150 is implemented at the mobile device 202 for a member of the online social networking service 100. In one example embodiment, as the member uses the mobile device 202, an application executing at the mobile device 202 may display one or more icons. As the member uses the mobile device 202, the badge algorithm server 220 may transmit an indicator to the icon modification system 150. In response, the icon modification system 150 determines a badge algorithm identified by the indicator and downloads the badge algorithm from the badge algorithm server 220.

In another example embodiment, the icon modification system 150, executing at the mobile device 202, executes the badge algorithm to modify one or more of the icon pixels. In one example, the icon modification system 150 overlays pixels over the icon pixels. In another example embodiment, the icon modification system 150 overwrites icon pixel values according to the badge algorithm by overwriting pixel values in a graphics memory. After modifying one or more of the icon pixels, the icon modification system 150 causes the icon pixels to be displayed at the display 240.

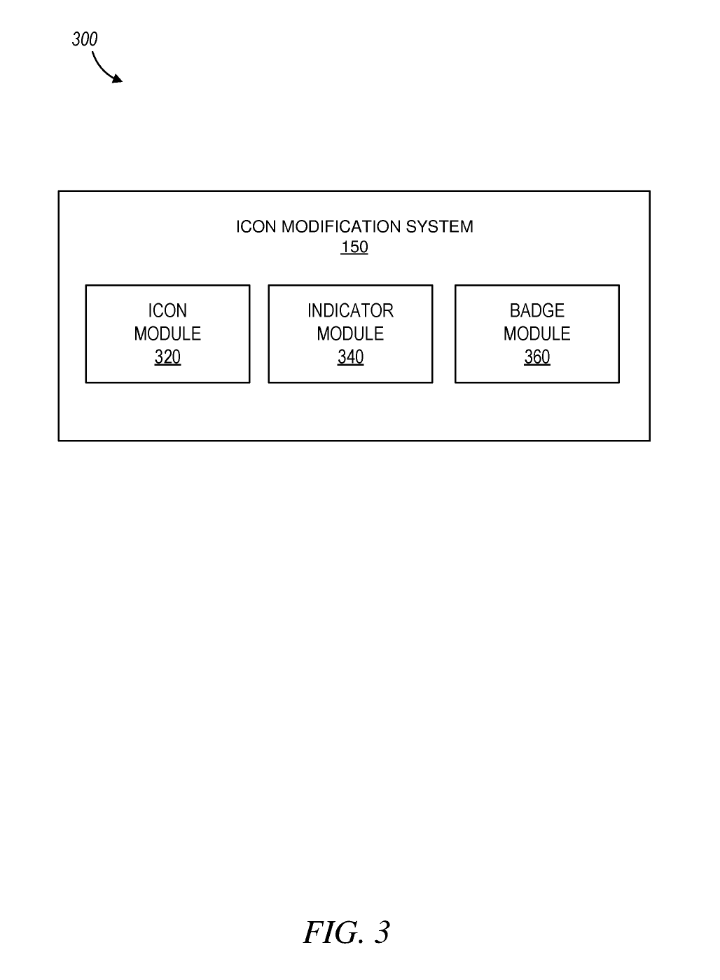

FIG. 3 is a block diagram illustrating another system 300 for modifying icon pixels according to a badge algorithm, according to one example embodiment. In one example embodiment, the system 300 includes the icon modification system 150 which includes an icon module 320, an indicator module 340, and a badge module 360.

In one example embodiment, the icon module 320 is configured to render icon pixels to a graphics memory (e.g., a portion of a main memory, such as a random access memory, that has been allocated to graphics or video; a dedicated hardware memory for graphics or video within a graphics rendering engine or another graphics processor; one or more frame buffers or raster memory within a display engine or other display processor; or any suitable combination thereof). As one skilled in the art may appreciate, writing pixel values to a graphics memory may cause the icon pixels to be displayed on a display device. As one skilled in the art may appreciate, icon pixels may be rendered according to a wide variety of different methods, and this disclosure is meant to include all such methods. In one example, the icon module 320 writes directly to a frame buffer. In another example, the icon module 320 renders icon pixels to a backup frame buffer. In such an example, as will be further described, the icon modification system 150 may employ a double buffering scheme to display icon pixels to a display screen.

In another example embodiment, the icon module 320 renders icon pixels as many times as needed to support the badge algorithm. In one example, the badge algorithm generates ten frames of animation. In this example, the icon module 320 renders the icon pixels for each frame of animation. In another example embodiment, the icon module 320 is needed to determine whether the member has selected the icon. In one example, the mobile device has a touch screen for interfacing with the member. In response to the member touching the screen at the location of the icon, the icon module 320 determines that the member has selected the icon.

In another example, the indicator module 340 is configured to receive an indicator that identifies a badge algorithm. In other embodiments, the indicator identifies the icon which is to be modified by the badge algorithm. In another example embodiment, the indicator identifies a type of media content that is available. In one example, additional media content is received by the online social networking service 100. In response to the online social networking service 100 determining that the member may view the additional media content, the badge algorithm server 220 may transmit the indicator to the indicator module 340.

In one example embodiment, several media content objects are available, and the indicator indicates the number of media content objects available. In response, the badge algorithm may adjust pixel values according to the number of media content objects available. In one example where several new media content objects are available, the badge algorithm may generate a faster animation as compared with an animation indicating a single new media content object being available. In one example, in response to one media object being available for download, the badge algorithm generates an animation at one frame per second. In another example, in response to two media objects being available for download, the badge algorithm generates an animation at five frames per second. In this way, the badge algorithm also indicates a number or amount of available media content.

In other embodiments, the indicator includes other attributes of a media content object that is available to a member of the online social networking service 100. In certain examples, the other attributes include a size of the media content object, a color of the media content object, a submitter of the media content object, or any other property or data associated with the media content object. In this way, the icon modification system 150 may notify the member that new media content is available and indicate any property of the media content object based on a variation of the badge algorithm. In this way, the icon modification system 150 can alert the member without disrupting the member's use of the mobile device 202.

In other example embodiments, the indicator further identifies a season. In one example, the season is a holiday. For example, in response to the season being Christmas, the indicator may identify the Christmas holiday. In response, the badge algorithm may add snow to an image, and a Santa Claus on the roof of a house depicted in the icon. In another example, the season is Halloween, and the badge algorithm darkens the icon pixels and adds a ghost image in the background of the icon. In another example, the season is a day of the week. For example, the indicator may indicate that today is Friday, and the badge algorithm may modify icon pixels accordingly. In another example, the season is the birthday of a member of the online social networking service 100. Of course, one skilled in the art may recognize other types of seasons, and this disclosure is not limited in this regard.

In another example embodiment, the plurality of badge algorithms are stored at the mobile device 202. In response to the indicator identifying which badge algorithm to use, the icon modification system 150 loads the badge algorithm from local storage and the badge module 360 executes the badge algorithm as described herein.

In one example embodiment, the badge module 360 is configured to execute the badge algorithm to modify one or more icon pixels. In one example embodiment, the badge module 360 modifies icon pixels by writing to a memory where the icon pixels are stored. In one example, the memory is a graphics memory. In another embodiment, the memory is a frame buffer. Of course, other forms of memory may be used, and this disclosure is not limited in this regard.

In another example embodiment, the badge module 360 modifies icon pixel values to generate a series of frames. In one example, the badge algorithm specifies ten animation frames, and the badge module 360 executes the badge algorithm to generate ten animation frames using the icon pixels.

In one example embodiment, the badge algorithm specifies a speed of the frames. In one example, the speed is two frames per second. Of course other values may be used, and this disclosure is not limited in this regard.

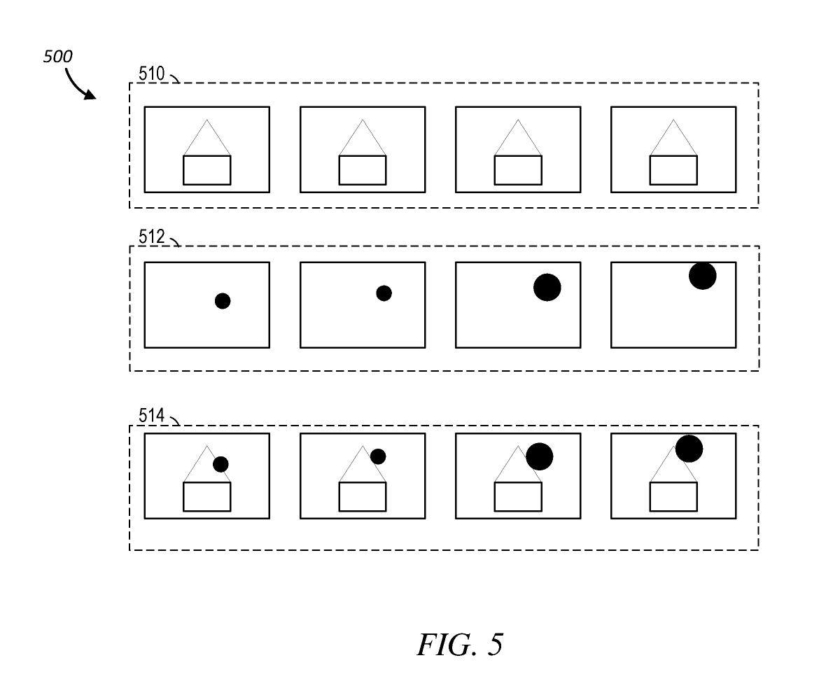

In one specific example, the badge algorithm specifies eight frames. In this example, the icon pixels depict a house with a chimney. In this example, the badge algorithm generates smoke coming from the chimney by altering pixel values in the graphics memory to depict smoke. In this example, a first frame may depict a small amount of smoke, while a last frame may depict significant amounts of smoke, with each frame in between depicting progressively larger amounts of smoke. A specific example is depicted in FIG. 5.

In one example embodiment, the badge algorithm loops the frames of the animation until a specified threshold period of time has elapsed. In one example, the threshold period of time is five seconds, and in response to the badge algorithm displaying the animation for more than five seconds, the badge module 360 suspends the animation.

In another example embodiment, the badge algorithm adjusts according to a color of the icon pixels. In one example, in response to the icon pixels being black and white, the badge algorithm generates black-and-white modifications to the icon pixels. In another example embodiment, in response to the icon pixels including many different colors, the badge algorithm may generate color modifications to the icon pixels.

In one example embodiment, the badge algorithm suspends display of the animation in response to the member selecting the icon. In this example embodiment, the intent of the badge algorithm may be to acquire the member's attention. In response to the member selecting the icon, the badge module 360 suspends the animation.

In another example embodiment, the badge module 360 executes the badge algorithm until a change is detected in the icon pixels. For example, as the member interacts with the mobile device 202, the member's interactions with the mobile device 202 may cause the icon to change. In one example, the icon changes from a black-and-white color scheme to a 16-color scheme in response to the member interacting with the icon. In response to the badge algorithm modifying the black-and-white version of the icon, and the mobile device 202 changing the icon from the black-and-white version to the 16-color version, the badge module 360 suspends animation.

In another example embodiment, the badge module 360 executes the badge algorithm to determine the color of an icon pixel. In one example where the icon pixel is black and the badge algorithm specifies a black pixel, the badge module 360 may write a black pixel to the graphics memory because there is agreement between the color of the pixel in the icon and the colors specified by the badge algorithm.

In another example embodiment, the icon pixel value at a specific pixel is black, but the badge algorithm specifies a white color for the pixel. In one example, the badge module 360 executes the badge algorithm to generate an average color between the color of the pixel from the icon and the color specified by the badge algorithm. In one example, in response to the icon pixel being black and the badge algorithm indicating the white pixel, the badge module 360 may determine to modify the pixel value at the location to a gray color that is between the color of the icon pixel and the color specified by the badge algorithm. In another example embodiment, the badge algorithm indicates a transparency value as previously described.

In another example embodiment, the badge module 360 executes the badge algorithm in response to the icon modification system 150 not currently being configured to display additional available media content. In one example, an application executing on the mobile device 202 is currently configured to display text messages. In this example, in response to the indicator module 340 receiving an indicator that additional media content is available, and the additional media content being a text message, the icon modification system 150 may simply display the text message. However, if the mobile device 202 is not currently configured to display text message, the badge module 360 executes the badge algorithm to notify the member of the available additional media content by modifying an icon that the member may use to view the media content.

In one example embodiment, the badge module 360 executes the badge algorithm considering the size of the icon. In one example where the badge algorithm depicts fireworks behind an image in the icon, the badge module 360 increases a size of the fireworks to be consistent with a size of the icon. In one example, as a member interacts with the icon modification system 150, the size of the icon may increase or decrease. Accordingly, the badge module 360 increases or decreases the size of graphical elements generated by the badge module 360 using the badge algorithm. In other embodiments, various badge algorithms may shake the icon at a given frequency, jiggle, fade, or include any other graphical effects or modifications.

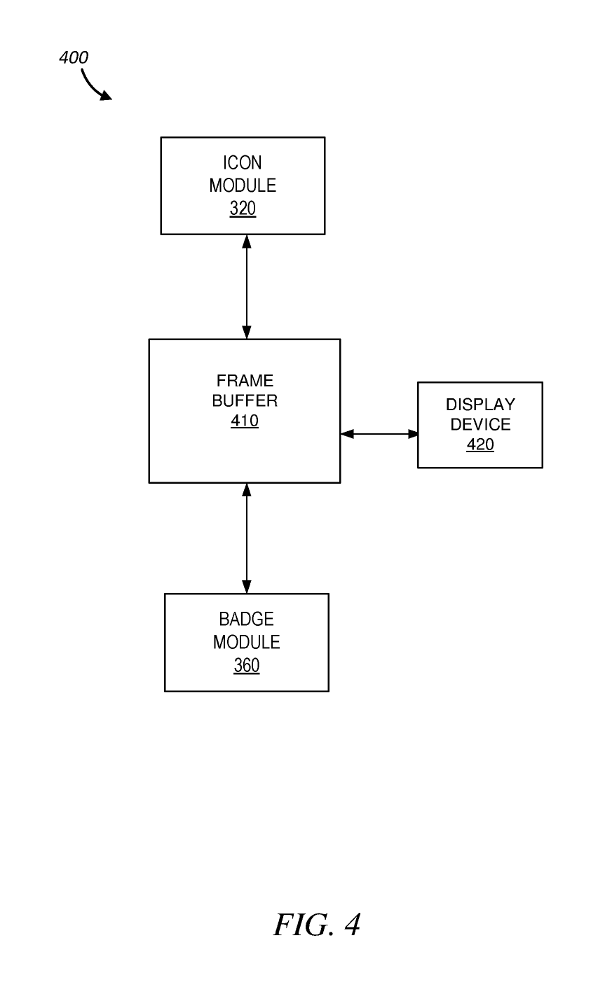

FIG. 4 is a block diagram illustrating a system 400 for modifying icon pixels according to a badge algorithm, according to an example embodiment. In one example embodiment, the system 400 includes the icon module 320, a frame buffer 410, the badge module 360, and a display device 420.

In one example, the display device 420 is configured to display graphical data stored in the frame buffer 410. In this example embodiment, the icon module 320 writes pixel values for the icon to the frame buffer 410. In response to the indicator module 340 receiving the indicator, the badge module 360 writes icon pixel values to the frame buffer 410 based on the badge algorithm. In one example embodiment, the icon module 320 is executed in one thread, while the badge module 360 is executed in a different thread. Therefore, one or more separate portions of the icon modification system 150 may be executed by more than one processor.

FIG. 5 is an illustration 500 depicting modifications to an icon using a badge algorithm, according to an example embodiment. In one example embodiment, the icon module 320 renders icon pixels to a graphics memory according to a stream 510 of four images. Similarly, the badge module 360 executes a badge algorithm and writes a second stream 512 of four images to the graphics memory. As indicated in FIG. 5, the badge algorithm results in a composite stream 514 of images based on the icon pixels and the modifications to the icon pixels performed by the badge module 360 using the badge algorithm.

In other examples, a badge algorithm adds graphical elements to an icon. In one example, a badge algorithm adds snow to a landscape icon. In another example, the badge algorithm depicts a sun setting in a background of the icon. Of course, the badge algorithm may modify imagery in an icon in any number of other ways, and this disclosure is not limited in this regard.

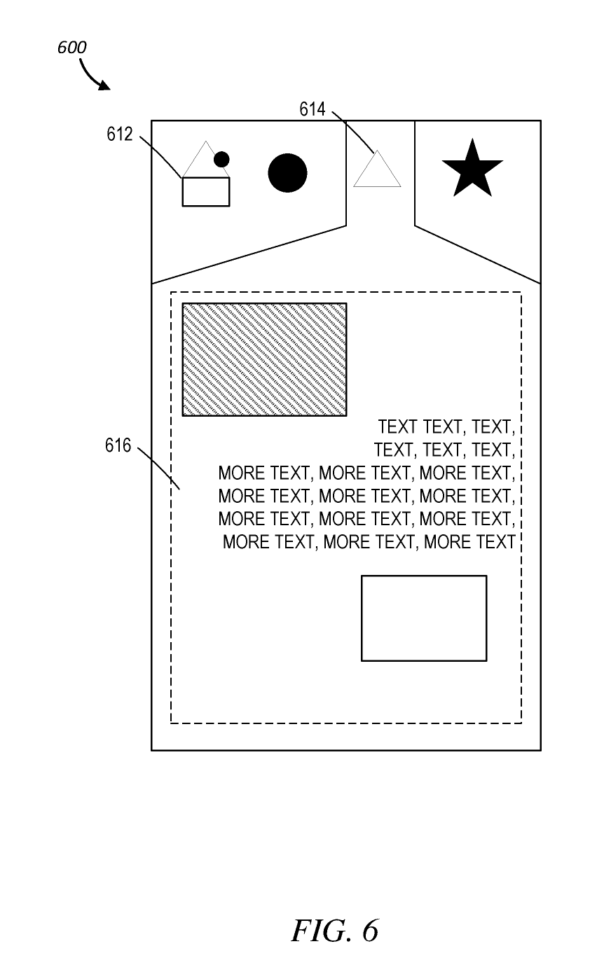

FIG. 6 is an illustration depicting a user interface 600 according to one example embodiment. In this example embodiment, the mobile device 202 generates the user interface 600 that includes four separate tabs, including tabs 612 and 614, at a top row of the user interface 600. In one example, the leftmost tab 612 includes the icon pixels that will be modified by the badge module 360.

In this example, the member is currently viewing the tab 614, resulting in a display of media content 616. In response to the indicator module 340 receiving an indicator to modify the icon associated with the tab 612, the badge module 360 executes the badge algorithm because the member is not currently viewing the tab 612. In another example embodiment, in response to the member viewing the tab 612, the icon modification system 150 may simply display the newly available media content without modifying the icon pixels. In another example embodiment, in response to the member viewing the tab 612, the badge module 360 may execute a different badge algorithm.

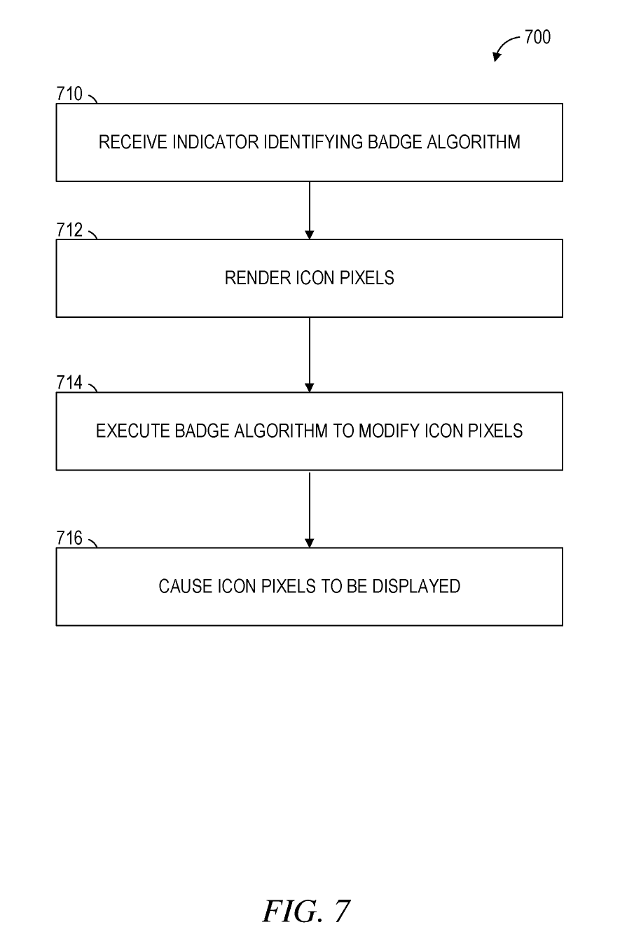

FIG. 7 is a flow chart diagram illustrating a method 700 of modifying icon pixels using a badge algorithm, according to another example embodiment. According to one example embodiment, the method 700 is performed by one or more modules of the icon modification system 150 and is described by a way of reference thereto.

In one example, the method 700 begins, and at operation 710, the indicator module 340 receives an indicator that identifies a badge algorithm from a plurality of badge algorithms. In one example, the indicator identifies a record number for a badge algorithm at a database of badge algorithms.

The method 700 continues at operation 712, and the icon module 320 renders icon pixels to a graphics memory. In one example, the icon module 320 writes an array of pixel values representing the icon to a frame buffer.

The method 700 continues at operation 714, and the badge module 360 executes the badge algorithm to modify one or more icon pixels by writing to a graphics memory where the icon pixels are stored. The method 700 continues at operation 716, and the badge module 360 causes the icon pixels to be displayed on the display screen. In one example, the badge module 360 transmits a message to an operating system for the mobile device 202 indicating that the modified icon pixels are to be displayed.

In another example embodiment, the operations 710 through 716 are repeated several times to generate an animation. In one example, the badge algorithm specifies six frames. In response, the badge module 360, for each of the six frames, modifies icon pixels and causes the resulting modified icon pixels to be displayed at the display screen. In one example embodiment, the badge module 360 determines a color for each pixel that is to be modified according to the badge algorithm. Of course, the badge module 360 may, at operation 714, consider transparency values for each pixel, and this disclosure is not limited in this regard.

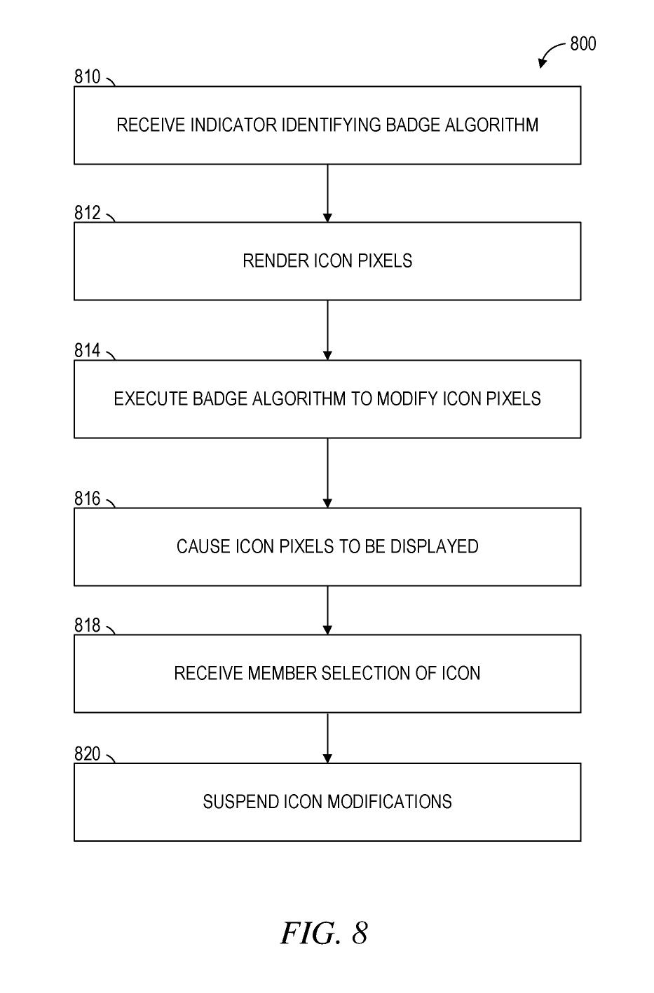

FIG. 8 is a flow chart diagram illustrating another method 800 of modifying icon pixels according to a badge algorithm, according to another example embodiment. According to one example embodiment, the method 800 is performed by one or more modules of the icon modification system 150 and is described by a way of reference thereto.

In one example embodiment, the method 800 begins, and at operation 810 the indicator module 340 receives an indicator that identifies the badge algorithm among a plurality of badge algorithms. The method 800 continues, and at operation 812 the icon module 320 renders icon pixels to a graphics memory as described herein. The method continues at operation 814, and the badge module 360 executes the badge algorithm.

The method continues at operation 816, and the badge module 360 causes the modified icon pixels to be displayed at a display screen. In one example, the badge module 360 is executing at a mobile device 202 and the display screen is a screen for the mobile device 202.

The method 800 continues at operation 818, and the icon module 320 receives a member selection of the icon. In one example, a key of a keyboard is mapped to the icon. In response to the member pressing the key mapped to the icon, the icon module 320 determines that the member has selected the icon. In another example, the member touches the icon via a touch screen and the icon module 320 determines that the member has selected the icon. Of course, one skilled in the art may recognize many other ways in which a member may select an icon, and this disclosure is meant to include all such ways.

The method continues at operation 820, and in response to the member selecting the icon at operation 818, the badge module 360 suspends modifications to the icon. In one example, suspending modifications results in suspending an animation.

### Modules, Components, and Logic

Certain embodiments are described herein as including logic or a number of components, modules, or mechanisms. Modules may constitute either software modules (e.g., code embodied on a machine-readable medium) or hardware modules. A “hardware module” is a tangible unit capable of performing certain operations and may be configured or arranged in a certain physical manner. In various example embodiments, one or more computer systems (e.g., a standalone computer system, a client computer system, or a server computer system) or one or more hardware modules of a computer system (e.g., a processor or a group of processors) may be configured by software (e.g., an application or application portion) as a hardware module that operates to perform certain operations as described herein.

In some embodiments, a hardware module may be implemented mechanically, electronically, or any suitable combination thereof. For example, a hardware module may include dedicated circuitry or logic that is permanently configured to perform certain operations. For example, a hardware module may be a special-purpose processor, such as a Field-Programmable Gate Array (FPGA) or an Application Specific Integrated Circuit (ASIC). A hardware module may also include programmable logic or circuitry that is temporarily configured by software to perform certain operations. For example, a hardware module may include software executed by a general-purpose processor or other programmable processor. Once configured by such software, hardware modules become specific machines (or specific components of a machine) uniquely tailored to perform the configured functions and are no longer general-purpose processors. It will be appreciated that the decision to implement a hardware module mechanically, in dedicated and permanently configured circuitry, or in temporarily configured circuitry (e.g., configured by software) may be driven by cost and time considerations.

Accordingly, the phrase “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software accordingly configures a particular processor or processors, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple hardware modules exist contemporaneously, communications may be achieved through signal transmission (e.g., over appropriate circuits and buses) between or among two or more of the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions described herein. As used herein, “processor-implemented module” refers to a hardware module implemented using one or more processors.

Similarly, the methods described herein may be at least partially processor-implemented, with a particular processor or processors being an example of hardware. For example, at least some of the operations of a method may be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API).

The performance of certain of the operations may be distributed among the processors, not only residing within a single machine, but deployed across a number of machines. In some example embodiments, the processors or processor-implemented modules may be located in a single geographic location (e.g., within a home environment, an office environment, or a server farm). In other example embodiments, the processors or processor-implemented modules may be distributed across a number of geographic locations.

### Machine and Software Architecture

The modules, methods, applications, and so forth described in conjunction with FIGS. 1-8 are implemented in some embodiments in the context of a machine and an associated software architecture. The sections below describe a representative architecture that is suitable for use with the disclosed embodiments.

Software architectures are used in conjunction with hardware architectures to create devices and machines tailored to particular purposes. For example, a particular hardware architecture coupled with a particular software architecture will create a mobile device, such as a mobile phone, tablet device, or so forth. A slightly different hardware and software architecture may yield a smart device for use in the “internet of things,” while yet another combination produces a server computer for use within a cloud computing architecture. Not all combinations of such software and hardware architectures are presented here, as those of skill in the art can readily understand how to implement the inventive subject matter in different contexts from the disclosure contained herein.

### Example Machine Architecture and Machine-Readable Medium

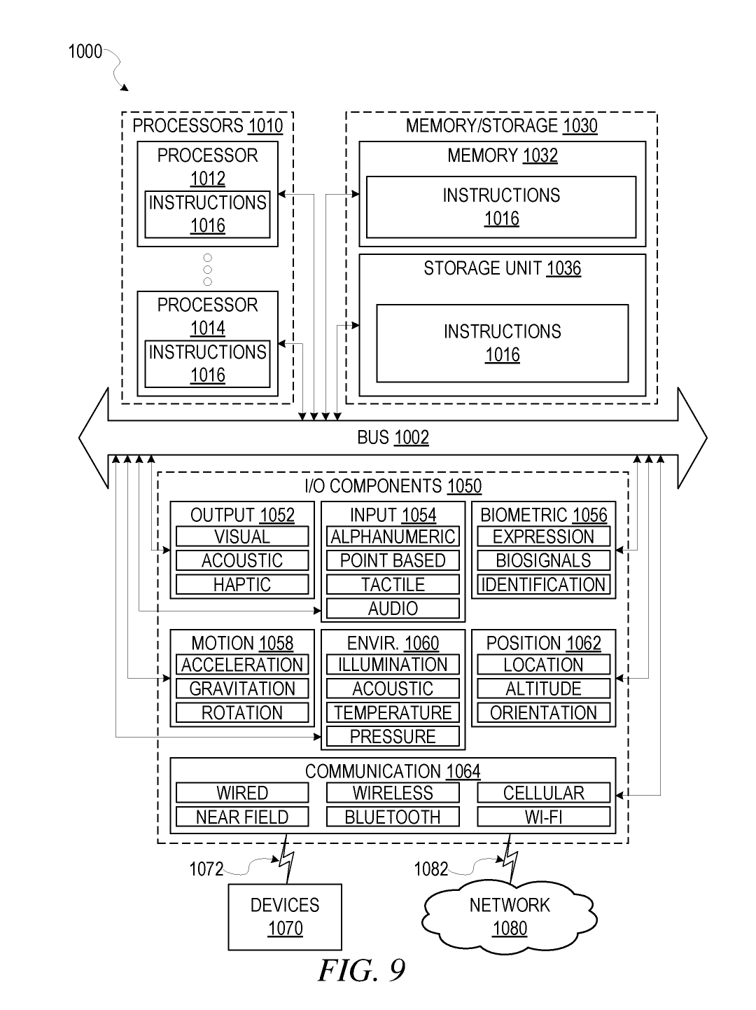

FIG. 9 is a block diagram illustrating components of a machine 1000, according to some example embodiments, able to read instructions from a machine-readable medium (e.g., a machine-readable storage medium) and perform any one or more of the methodologies discussed herein

Specifically, FIG. 9 shows a diagrammatic representation of the machine 1000 in the example form of a computer system, within which instructions 1016 (e.g., software, a program, an application, an applet, an app, or other executable code) for causing the machine 1000 to perform any one or more of the methodologies discussed herein may be executed. For example the instructions 1016 may cause the machine 1000 to execute the flow diagrams of FIGS. 7-8. Additionally, or alternatively, the instructions 1016 may implement one or more of the components of FIG. 3. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a personal digital assistant (PDA), or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory/storage 1030, and I/O components 1050, which may be configured to communicate with each other such as via a bus 1002. In an example embodiment, the processors 1010 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 1012 and a processor 1014 that may execute the instructions 1016. The term “processor” is intended to include multi-core processors that may comprise two or more independent processors (sometimes referred to as “cores”) that may execute instructions contemporaneously. Although FIG. 9 shows multiple processors, the machine 1000 may include a single processor with a single core, a single processor with multiple cores (e.g., a multi-core processor), multiple processors with a single core, multiple processors with multiples cores, or any combination thereof.

The memory/storage 1030 may include a memory 1032, such as a main memory, or other memory storage, and a storage unit 1036, both accessible to the processors 1010 such as via the bus 1002. The storage unit 1036 and memory 1032 store the instructions 1016 embodying any one or more of the methodologies or functions described herein. The instructions 1016 may also reside, completely or partially, within the memory 1032, within the storage unit 1036, within at least one of the processors 1010 (e.g., within the processor's cache memory), or any suitable combination thereof, during execution thereof by the machine 1000. Accordingly, the memory 1032, the storage unit 1036, and the memory of the processors 1010 are examples of machine-readable media.

As used herein, “machine-readable medium” means a device able to store instructions and data temporarily or permanently and may include, but not be limited to, random-access memory (RAM), read-only memory (ROM), buffer memory, flash memory, optical media, magnetic media, cache memory, other types of storage (e.g., Erasable Programmable Read-Only Memory (EEPROM)), and/or any suitable combination thereof. The term “machine-readable medium” should be taken to include a single medium or multiple media (e.g., a centralized or distributed database, or associated caches and servers) able to store the instructions 1016. The term “machine-readable medium” shall also be taken to include any medium, or combination of multiple media, that is capable of storing instructions (e.g., instructions 1016) for execution by a machine (e.g., machine 1000), such that the instructions, when executed by one or more processors of the machine 1000 (e.g., processors 1010), cause the machine 1000 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

The I/O components 1050 may include a wide variety of components to receive input, provide output, produce output, transmit information, exchange information, capture measurements, and so on. The specific I/O components 1050 that are included in a particular machine 1000 will depend on the type of machine. For example, portable machines such as mobile phones will likely include a touch input device or other such input mechanisms, while a headless server machine will likely not include such a touch input device. It will be appreciated that the I/O components 1050 may include many other components that are not shown in FIG. 9. The I/O components 1050 are grouped according to functionality merely for simplifying the following discussion and the grouping is in no way limiting. In various example embodiments, the I/O components 1050 may include output components 1052 and input components 1054. The output components 1052 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062 among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Position System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via coupling 1082 and coupling 1072 respectively. For example, the communication components 1064 may include a network interface component or other suitable device to interface with the network 1080. In further examples, the communication components 1064 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a Universal Serial Bus (USB)).

Moreover, the communication components 1064 may detect identifiers or include components operable to detect identifiers. For example, the communication components 1064 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

### Transmission Medium

In various example embodiments, one or more portions of the network 1080 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The term “transmission medium” shall be taken to include any intangible medium that is capable of storing, encoding, or carrying the instructions 1016 for execution by the machine 1000, and includes digital or analog communications signals or other intangible media to facilitate communication of such software.

### Language

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure. Such embodiments of the inventive subject matter may be referred to herein, individually or collectively, by the term “invention” merely for convenience and without intending to voluntarily limit the scope of this application to any single disclosure or inventive concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

1. A system comprising:
a machine-readable medium having instructions stored thereon, which, when executed by a processor, perform operations comprising:
receiving an indicator, the indicator identifying a badge algorithm among a plurality of badge algorithms;
rendering icon pixels to a graphics memory;
executing the badge algorithm to modify one or more of the icon pixels by writing to the graphics memory; and
causing the icon pixels to be displayed on a display screen.

2. The system of claim 1, wherein the operations of receiving, rendering, executing, and causing are performed multiple times resulting in an animation using the icon pixels, the badge algorithm specifying multiple stages of the animation.

3. The system of claim 1, wherein the instructions further cause the system to suspend the badge algorithm in response to any one of a threshold period of time having elapsed, a user selecting the icon, or a change in the icon.

4. The system of claim 1, wherein a color of one of the icon pixels is determined by the badge algorithm by combining, at a location of the icon pixel, a color of the icon pixel and a color defined by the badge algorithm.

5. The system of claim 4, wherein the combining comprises multiplying a color value of the icon pixel by a transparency value and combining a product with the color defined by the badge algorithm.

6. The system of claim 1, wherein the badge algorithm modifies the one or more icon pixels based on a season identified by the indicator.

7. The system of claim 6, wherein the season is selected from a holiday; a weekday, a weather pattern, and a birthday.

8. The system of claim 1, wherein the badge algorithm adjusts according to a size or color of the icon pixels.

9. The system of claim 1, wherein the executing of the badge algorithm occurs in response to receiving a content indicator that additional content is available from a remote server or has been received from the remote server.

10. The system of claim 1, wherein the badge algorithm modifies the one or more icon pixels based on a type of additional content available from a remote server.

11. A method comprising:
receiving an indicator that media content is available, the indicator identifying a badge algorithm among a plurality of badge algorithms;
rendering icon pixels to a graphics memory;
executing the badge algorithm to modify one or more of the icon pixels by writing to the graphics memory; and
causing the icon pixels to be displayed on a display screen.

12. The method of claim 11, wherein the steps of receiving, rendering, executing, and causing are performed multiple times resulting in an animation using the icon pixels, the badge algorithm specifying multiple stages of the animation.

13. The method of claim 11, further comprising suspending the badge algorithm in response to any one of a threshold period of time having elapsed, a user selecting the icon, or a change in the icon.

14. The method of claim 11, wherein a color of one of the icon pixels is determined by the badge algorithm by combining, at a location of the icon pixel, a color of the icon pixel and a color defined by the badge algorithm for the location.

15. The method of claim 14, wherein the combining comprises multiplying a color value of the icon pixel by a transparency value and combining a product with the color defined by the badge algorithm.

16. The method of claim 11, wherein the badge algorithm modifies the one or more icon pixels based on a season identified by the indicator.

17. The method of claim 16, wherein the season is selected from a holiday, a weekday, a weather pattern, and a birthday.

18. A non-transitory machine-readable medium having instructions stored thereon, which, when executed by a processor, cause the processor to perform operations including:
receiving an indicator, the indicator identifying a badge algorithm among a plurality of badge algorithms;
rendering icon pixels to a graphics memory;
executing the badge algorithm to modify one or more of the icon pixels by writing to the graphics memory; and
causing the icon pixels to be displayed on a display screen.

19. The machine-readable medium of claim 18, wherein the operations of receiving, rendering, executing, and causing are performed multiple times resulting in an animation using the icon pixels, the badge algorithm specifying multiple stages of the animation.

20. The machine-readable medium of claim 18, wherein the instructions further cause the processor to suspend the badge algorithm in response to any one of a threshold period of time having elapsed, a user selecting the icon, or a change in the icon.
